(19) United States
(12) Patent Application Publication
(10) Pub. No.: US 2024/0396102 A1
(43) Pub. Date: Nov. 28, 2024

(54) POWER STORAGE DEVICE AND METHOD OF CONTROLLING THE SAME

(71) Applicant: TOYOTA JIDOSHA KABUSHIKI KAISHA, Toyota-shi (JP)

(72) Inventor: Naoki Osada, Toyota-shi (JP)

(73) Assignee: TOYOTA JIDOSHA KABUSHIKI KAISHA, Toyota-shi (JP)

(21) Appl. No.: 18/427,068

(22) Filed: Jan. 30, 2024

(30) Foreign Application Priority Data
May 22, 2023 (JP) 2023-083989

(51) Int. Cl. H01M 10/44; H01M 10/48; H02J 7/00

(52) U.S. Cl. CPC H01M 10/441; H01M 10/482; H02J 7/0029; H01M 2220/20

(57) ABSTRACT

The power storage device according to the present disclosure includes a battery stack and a deformation detection sensor for detecting a deformation amount of the battery stack, and an average expansion rate of the battery stack in a range of 80 to 100% of charge is 2.8 times or more of an average expansion rate of the battery stack in a range of 0 to 80% of charge rate.

### CROSS-REFERENCE TO RELATED APPLICATION

This application claims priority to Japanese Patent Application No. 2023-083989 filed on May 22, 2023, incorporated herein by reference in its entirety.

### BACKGROUND

### 1. Technical Field

The present disclosure relates to a power storage device and a method of control the same.

### 2. Description of Related Art

Japanese Unexamined Patent Application Publication No. 2016-99193 (JP 2016-99193 A) and Japanese Unexamined Patent Application Publication No. 2016-31360 (JP 2016-31360 A) disclose a method of detecting deformation of a sealed secondary battery, including detecting a change in an external field caused by deformation of a polymer matrix layer and detecting deformation of the sealed secondary battery based on the detected change.

Japanese Unexamined Patent Application Publication No. 2012-234629 (JP 2012-234629 A) discloses a power storage device including a measuring element that measures distortion caused by the application of a force that changes the shape of a capacitor, the power storage device detecting the state of the capacitor according to the result of measuring the distortion obtained from the measuring element, and detecting an abnormality of the capacitor from the detection result.

### SUMMARY

According to the related art, there is a possibility that the detection accuracy of the state of charge, in particular, the detection accuracy of an abnormality at the time of overcharge, is lowered.

The present disclosure has been made in view of the such an issue, and provides a power storage device with improved detection accuracy of a state of charge, in particular, improved detection accuracy of an abnormality at the time of overcharge.

A first aspect of the present disclosure provides a power storage device. The power storage device includes a battery stack and a deformation detection sensor that detects an amount of deformation of the battery stack; and an average expansion rate of the battery stack at a charging rate in a range of 80 to 100% is 2.8 times or more of an average expansion rate of the battery stack at a charging rate in a range of 0 to 80%.

### Second Aspect

The power storage device according to the first aspect, in which: the battery stack includes a positive electrode current collector layer, a positive electrode active material layer, a separator layer or a solid electrolyte layer, a negative electrode active material layer, and a negative electrode current collector layer arranged in this order; and the negative electrode active material layer includes at least artificial graphite.

### Third Aspect

A method of controlling the power storage device according to the first or second aspect, wherein charging of the power storage device is stopped when the amount of deformation detected by the deformation detection sensor during the charging exceeds a predetermined value.

According to the present disclosure, it is possible to obtain a power storage device with improved detection accuracy of a state of charge, in particular, improved detection accuracy of an abnormality at the time of overcharge.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flow chart of a control process for a storage battery according to an embodiment; and

FIG. 2 is a graph showing the relation between the charge rate and the battery cell expansion rate of the lithium-ion battery manufactured in the embodiments.

### DETAILED DESCRIPTION OF EMBODIMENTS

The power storage device of the disclosed embodiment may be a lithium-ion battery, particularly a lithium-ion battery used as an in-vehicle battery such as a hybrid electric vehicle, battery electric vehicle. Hereinafter, an example of the power storage device according to the embodiment of the present disclosure will be specifically described. The power storage device of the present disclosure is not limited to this embodiment.

The power storage device of the present disclosure includes a battery stack and a deformation detection sensor that detects a deformation amount of the battery stack.

### Battery Stack

The average expansion coefficient of the battery stack varies depending on the charging rate. The average expansion rate of the battery stack in the range of the charge rate 80 to 100% is 2.8 times or more the average expansion rate of the battery stack in the range of the charging rate 0 to 80%. For example, the average expansion rate of the battery stack in the range of 80 to 100% of the charging rate may be 3.0 times or more, 4.0 times or more, 5.0 times or more, 6.0 times or more, 7.0 times or more, 8.0 times or more, or 9.0 times or more, and may be 20.0 times or less, 19.0 times or less, 18.0 times or less, 17.0 times or less, 16.0 times or less, 15.0 times or less, 14.0 times or less, 13.0 times or less, 12.0 times or less, 11.0 times or less, or 10.0 times or less of the average expansion rate of the battery stack in the range of the charging rate 0 to 80%.

Although the phenomenon in which the battery stack specifically swells is not preferable from the viewpoint of restraining the battery, it is possible to improve the detection accuracy of the state of charge, in particular, the abnormality detection accuracy at the time of overcharge. In order to specifically expand the battery stack as in the present disclosure, that is, in order to increase the expansion rate of the battery stack in the range of the normal use range, and the expansion rate of the battery stack in the range of the charge rate of 0 to 80%, it is possible to use a specific negative electrode active material, adjust the capacity ratio of the positive electrode and the negative electrode, adjust the blending ratio of the active material in the active material layer, and adjust the density of the active material layer.

The battery stack may have a positive electrode current collector layer, a positive electrode active material layer, a separator layer or a solid electrolyte layer, a negative electrode active material layer, and a negative electrode current collector layer in this order, and the power storage device may have a bipolar structure in which a plurality of battery stacks are electrically connected.

### Positive Electrode Current Collector Layer

The positive electrode current collector layer may comprise a metal foil. The metal foil may be an aluminum foil, a metal foil such as SUS, Cu, Ni, Fe, Ti, Co or Zn, a foil using a cladding material of a metal such as SUS, Cu, Ni, Fe, Ti, Co or Zn and Al, or a foil coated with Al on a metal surface. In particular, the metal foil may be an aluminum foil.

The metal foil may have, on its surface, a carbon material and a binder to which the carbon material is bonded. The carbon material may be acetylene black, furnace black, channel black, thermal black, activated carbon, carbon, carbon fiber, graphite, or the like. The binder may be PESE (polyethylene sebacate), PPSU (polyphenylsulfone), PBI (polybenzimidazole), PESU (polyethersulfone), or the like. The binder may be PVdF (polyvinylidene fluoride), BR (butylene rubber), SBR (styrene-butadiene rubber), or the like.

### Positive Electrode Active Material Layer

The positive electrode active material may be, for example, an oxide active material. Ternary active materials and lithium iron phosphate active materials are preferred. The shape of the positive electrode active material may be, for example, particulate. The content of the positive electrode active material in the positive electrode active material layer is not limited. The content may be, for example, 40% by mass or more and 99% by mass or less, and is preferably 90% by mass or more.

### Separator Layer

The separator layer may be an inorganic porous layer impregnated with an electrolyte solution. For example, the inorganic porous layer may comprise inorganic particulates such as aluminum oxide/hydroxide, boehmite, titania, magnesia, and zirconia. The mean particle size of the inorganic fine particles may be, for example, from 10 nm to 50 micrometers. The separator layer may be a porous polymer layer impregnated with an electrolytic solution.

### Solid Electrolyte Layer

The solid electrolyte layer contains at least a solid electrolyte. A binder may further be included. The solid electrolyte may be, for example, an inorganic solid electrolyte such as a sulfide solid electrolyte. The shape of the solid electrolyte may be, for example, particulate. The average particle diameter of the particulate solid electrolyte may be, for example, 0.1 μm or more and 50 μm or less. The binder may be PVdF (polyvinylidene fluoride), BR (butylene rubber), SBR (styrene-butadiene rubber), or the like.

### Negative Electrode Active Material Layer

It is preferable that the negative electrode active material is capable of occluding and releasing metal ions, and that the expansion rate increases at the end of charging. As such a material, artificial graphite may be used. Here, the artificial graphite is artificially produced graphite, and is sometimes referred to as synthetic graphite. Human graphite is generally obtained by heat treatment with coal coke as a raw material and graphitization.

The particles of the negative electrode active material may be formed into secondary particles by granulating single particles. The negative electrode active material layer may further include a binder. The binder may be PVdF (polyvinylidene fluoride), BR (butylene rubber), SBR (styrene-butadiene rubber), or the like. The content of the negative electrode active material in the negative electrode active material layer is not limited. The content may be, for example, 40 mass % or more and 100 mass % or less, and is preferably 90 mass % or more.

### Negative Electrode Current Collector Layer

The negative electrode current collector layer may be the same as the positive electrode current collector layer, but a copper foil is preferably used as the metal foil.

The amount of the negative electrode active material layer supported on the negative electrode current collector layer may be, for example, 10 mg/cm² or more, and may be 15 to 50 mg/cm². In addition, in the normal use range, the capacity ratio of the positive electrode active material and the negative electrode active material can be adjusted so that the expansion rate of the battery stack increases only when the battery stack expands appropriately and falls into an overcharge state, for example, the capacity ratio may be set to 1.05 to 1.2.

### Deformation Detection Sensor

The deformation detection sensor is not limited as long as it detects the deformation amount of the battery stack. The deformation detection sensor may be, for example, a linear potentiometer whose output voltage varies with linear movement of the contact. The deformation detection sensor may be a sensor that detects displacement of the battery stack by a piezoelectric element.

### Method of Controlling Power Storage Device

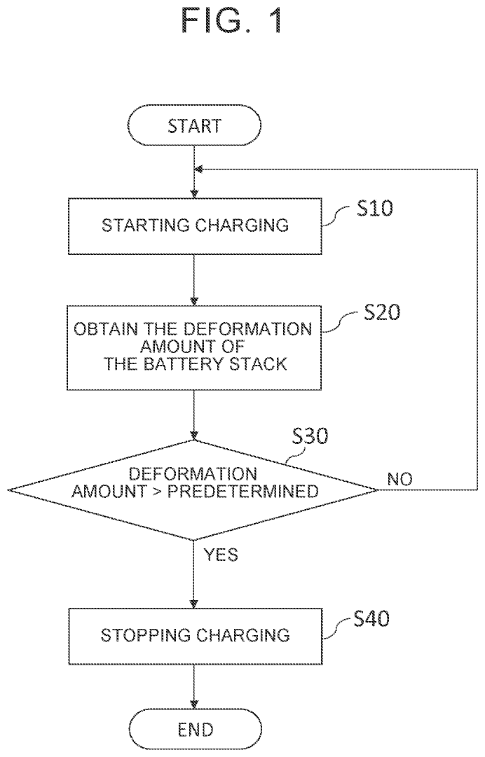

As shown in FIG. 1, the power storage device of the present embodiment can suppress overcharge by stopping the charging of the power storage device when the deformation amount of the battery stack detected by the deformation detection sensor during charging exceeds a predetermined value.

In general, in-vehicle batteries are said to have a high frequency of use with a charge rate of about 10 to 90%. If the battery is overcharged due to some fail mode, the battery may become unstable. Therefore, it is necessary to detect this in advance and maintain the battery in a safe state. According to the present embodiment, when the battery is charged to the outside of the normal use range, the expansion rate of the battery stack is remarkably increased, so that abnormality detection of expansion is facilitated, and the battery can be maintained in a safe state.

Although the mechanism of exhibiting such expansion characteristics at the end-of-charge stage has not been clarified, it is presumed that the mechanism is related to the crystal arrangement and crystallite size in the active material. Specifically, when Li is inserted between the graphitic layers, strain is accumulated between adjacent crystals, the strain cannot be absorbed by voids or the like, it is considered to be a trigger to expand to the outside.

In addition, when the negative electrode active material is converted into secondary particles, since the particles are granulated while being compressed when the negative electrode active material is converted into secondary particles, it is considered that strain accumulates in the secondary particles. When the single particles expand in this state, the expansion strain is also partially absorbed into the voids inside the secondary particles. However, when a certain expansion coefficient is reached, it is considered that the strain cannot be absorbed by the void and expands to the outside. At this time, at the same time, the strain at the time of granulation compression is relaxed, it is estimated that the amount of expansion to the outside becomes larger.

Hereinafter, the present disclosure will be described in more detail with reference to Examples. The following examples are illustrative and do not limit the present disclosure. In the following embodiments, “graphite A” used as the negative electrode active material is artificial graphite in which the expansion rate increases at the end of the charge reaction (6C+Li→C₆Li), artificial graphite in which the expansion rate of “graphite B” is smaller than that of graphite A, and “graphite C” is natural graphite.

### Example 1

### Preparation of Negative Electrode

First, a negative electrode including a negative electrode active material layer and a negative electrode current collector layer was prepared. Graphite A as the negative electrode active material, a binder (styrene butadiene rubber: SBR), and a thickener (carboxymethylcellulose: CMC) were mixed so as to have a weight-ratio of 97:1.5:1.5, distilled water was added so that the solid content ratio became 55-60%, and then the mixture was thoroughly kneaded using a kneader to obtain a negative electrode paste that became a negative electrode active material layer. The obtained negative electrode paste was applied onto a copper foil serving as a current collector layer using a doctor blade, dried at 100° C. for 15 minutes, and the water was completely evaporated to prepare a negative electrode layer. At this time, the amount of the negative electrode layers after being dried was adjusted so as to have a 12 mg/cm². The prepared negative electrode was subjected to a biaxial roll press to be compressed so as to have a 1.5 g/cc density, thereby obtaining a pressed negative electrode.

### Fabrication of Positive Electrode

Next, a positive electrode including a positive electrode active material layer and a positive electrode current collector layer was prepared. As the positive electrode active material, LiNi_{0.33}Mn_{0.33}Co_{0.33}O₂ which is a transition-metal oxide was used, and the positive electrode active material, the conductive auxiliary agent (acetylene black: AB), and the binder (polyvinylidene fluoride: PVdF) were mixed in a weight-ratio of 95:2.5:2.5, and N-methylpyrrolidone: NMP was added as solvents, and the particles were sufficiently dispersed using a kneader or the like to obtain a positive electrode paste. The positive electrode paste was applied onto an aluminum foil serving as a current collector using a doctor blade or the like, and dried in an 80° C. environment for 15 minutes or more to prepare a positive electrode layer. The loading of the positive electrode layers was adjusted to 22 mg/cm². The positive electrode layers were rolled and pressed so as to have a 2.8 g/cc density.

### Preparation of a Li-Ion Cell

A lithium ion battery was fabricated using the prepared negative electrode and positive electrode. The positive electrode layer and the negative electrode layer were stacked so as to oppose each other, and a separator was disposed between the electrodes to electrically insulate them. As the separator, a film made of polyethylene as a base material was used. The prepared laminate was wrapped with a laminated film, and the electrolyte solution was injected, followed by sealing with a-80 kPa in vacuo to form a lithium-ion battery. As the electrolyte, carbonate-based solvents mixed at a ratio of EC:DMC:EMC=3:4:3 were used, and lithium hexafluoride phosphate (LiPF₆) was 1.2M dissolved as a lithium salt.

### Examples 2 to 3 and Comparative Examples 1 to 6

As shown in Table 1 below, lithium ion batteries of Examples 2 to 3 and Comparative Examples 1 to 6 were prepared in the same manner as in Example 1 except that the negative electrode active material and the electrode density after pressing were changed.

### Evaluation Method

The lithium ion batteries of Examples and Comparative Examples were evaluated by the following method.

### Expansion Coefficient

The manufactured lithium ion battery was attached to a restraint jig equipped with a contact displacement meter, and was connected to a charging and discharging device to perform charging and discharging. When the expansion coefficient was measured, 0.1C was charged from 2.5V to 4.25V. The expansion coefficient (%) was calculated by dividing the displacement amount obtained at this time by the thickness at the time of manufacturing the battery.

### Expansion Characteristic

2.5V was set at a charge rate of 0% and 4.25V was set at a charge rate of 100%, and the slope of the change in the expansion rate up to 80% was measured to obtain an expansion rate A (expansion rate (%)/charging rate (%)). Similarly, the slope of the change in the expansion rate (%) with respect to the charging rate from the charging rate of 80% to the charging rate of 100% was measured, the expansion rate B (expansion rate (%)/charging rate (%)). The expansion degree X was defined as the expansion degree X=the expansion rate B/expansion rate A.

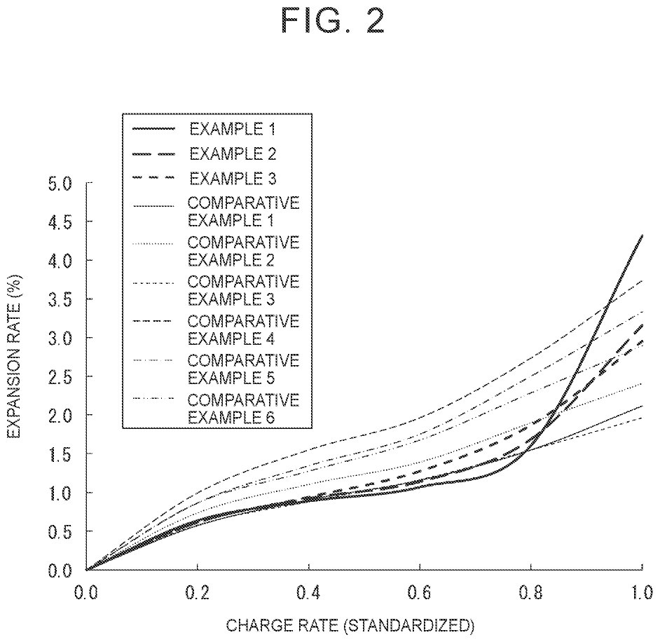

The results are shown in Table 1. FIG. 2 shows the relationship between the normalized charge rate (%) and the expansion rate (%). In the lithium ion batteries of Examples 1 to 3 in which the battery expansion degree X was 2.8 or more, it was possible to appropriately detect abnormality during overcharge. In Comparative Examples 1 to 6 in which the expansion degree X is less than 2.8, an abnormality at the time of overcharge could not be detected in some cases.

TABLE 1

| | Negative | | Expansion | Expansion | | |
|---|---|---|---|---|---|---|
| | active | Electrode-density | rate | rate | Expanding | Error |
| | material | g/cc | A %/% | B %/% | rate X | detection |
| Example 1 | Graphite A | 1.5 | 1.51 | 14.22 | 9.4 | ∘ |
| Example 2 | Graphite A | 1.4 | 1.77 | 7.60 | 4.3 | ∘ |
| Example 3 | Graphite A | 1.2 | 1.99 | 5.66 | 2.8 | ∘ |
| Comparative | Graphite B | 1.4 | 1.73 | 2.89 | 1.7 | x |
| Example 1 | | | | | | |
| Comparative | Graphite B | 1.4 | 1.99 | 2.68 | 1.3 | x |
| Example 2 | | | | | | |
| Comparative | Graphite B | 1.0 | 1.70 | 2.04 | 1.2 | x |
| Example 3 | | | | | | |
| Comparative | Graphite C | 1.6 | 2.88 | 5.21 | 1.8 | x |
| Example 4 | | | | | | |
| Comparative | Graphite C | 1.5 | 2.71 | 4.45 | 1.6 | x |
| Example 5 | | | | | | |
| Comparative | Graphite C | 1.2 | 2.38 | 3.13 | 1.3 | x |
| Example 6 | | | | | | |

What is claimed is:

1. A power storage device comprising a battery stack and a deformation detection sensor that detects an amount of deformation of the battery stack, wherein an average expansion rate of the battery stack at a charging rate in a range of 80 to 100% is 2.8 times or more of an average expansion rate of the battery stack at a charging rate in a range of 0 to 80%.

2. The power storage device according to claim 1, wherein:
the battery stack includes a positive electrode current collector layer, a positive electrode active material layer, a separator layer or a solid electrolyte layer, a negative electrode active material layer, and a negative electrode current collector layer arranged in this order; and
the negative electrode active material layer includes at least artificial graphite.

3. A method of controlling the power storage device according to claim 1, wherein charging of the power storage device is stopped when the amount of deformation detected by the deformation detection sensor during the charging exceeds a predetermined value.
